(19) United States
(12) Patent Application Publication
(10) Pub. No.: US 2012/0081337 A1
(43) Pub. Date: Apr. 5, 2012

(54) Active Acoustic Multi-Touch and Swipe Detection for Electronic Devices

(75) Inventors: William O. Camp, JR., Chapel Hill, NC (US); Paul Futter, Cary, NC (US); Leland Scott Bloebaum, Cary, NC (US)

(73) Assignee: Sony Ericsson Mobile Communications AB, Lund (SE)

(21) Appl. No.: 12/897,099

(22) Filed: Oct. 4, 2010

(51) Int. Cl. G06F 3/043

(52) U.S. Cl. 345/177

(57) ABSTRACT

An electronic device has a display, a controller, and a pair of haptic transducers connected to the display. The controller configures the haptic transducers to momentarily vibrate the display. A pair of sensors disposed on the display detects variations caused by the user touch in the vibrations. Based on an analysis of these variations, the controller can determine whether a user performed at least one of a swipe action and a multi-touch action, across the display.

### FIELD OF THE INVENTION

The present invention relates generally to electronic devices having displays, and more particularly to electronic devices that implement methods of touch location.

### BACKGROUND

Touch-sensitive displays are commonly used in many different types of electronic devices. As is known in the art, touch-sensitive displays are electronic visual displays configured to detect the presence and location of a user's touch within the display area. Conventionally, touch-sensitive displays detect the touch of a human a finger or hand, but may also be configured to detect the touch of a stylus or of some other passive object. Although there are many different types of touch-sensitive devices, many are configured to detect a user touch by sensing pressure, detecting a change in resistance, or by measuring an amount of reflected light, for example.

Additionally, devices may now determine the location of a user touch by performing a passive sonic analysis of the noise that is made when the user touches the display. In practice, the device includes two microphones placed in carefully selected locations on the surface of the display. When a user touches the display, the microphones capture and analyze the acoustical signatures produced by the touch to determine the location of the touch. For example, the devices may compare the captured acoustic signature to a table of predetermined acoustic signatures that correspond to different locations on the display. if a match is found, the device has determined the location of the user touch.

Although useful, passive acoustic methods of locating the position of a user touch on a display remain problematic. For example, because a user may touch the display at any time, the audio processing function that analyzes the resultant sound must be active all of the time. These types of solutions require a significant amount of power, due both to the sensors and, more importantly, to a processor executing sound analysis software. For smaller, battery-powered devices, such as cellular telephones, this extra power consumption means that the device will require either a larger battery or more frequent recharging, neither of which is desirable from the user's perspective.

Another problem with passive methods is that the display and/or the integration of the requisite mechanical components (e.g., the microphones) must be unique for each model of the device. This is because the ability of the passive acoustic methods to determine the location of a user touch varies across the surface of the display. Consequently, each model must undergo an analysis to determine the correct positioning for both microphones as well as the relationship between the acoustic signatures and the location of the touch.

Further, passive acoustic methods necessarily require a sound to be made when the user touches the display surface. This does not always occur when the user touches the display with a finger. Additionally, even when the microphones do detect the sound of a user touch, the accuracy of any given passive acoustic method may vary with the force of the touch. Moreover, passive acoustic methods may be computationally complex and slow since they involve searching tables of predetermined signatures to obtain one that most closely resembles the captured acoustic signature. Often times, such methods may not be able to provide a closed or unique solution. Moreover, they cannot handle certain types of user input actions, such as a “swipe” or “multi-touch” situations, where a user moves a finger or object (e.g., a stylus) across the surface of a display while maintaining contact with the display. This is likely due to the inability of these methods to detect such actions.

Currently, some devices now utilize haptic technology (i.e., “haptics”) to render feedback to the user. Haptics is a tactile feedback technology that applies forces, vibrations, and/or motions to a user by vibrating or shaking a display being touched by the user. The devices that cause the vibrations are called “haptic transducers.” The user senses these vibrations and perceives them as if the user had depressed a key on a keyboard, for example. Although haptics may be used to induce the user's perception that a key has been depressed, it is not known for use in determining whether a user performed a “swipe” input action, a “multi-touch” input action, or some other action that requires contact between one or more user fingers and the surface of a display.

### SUMMARY

The present invention provides an active acoustic method of determining whether a user performed at least one of a swipe action and a multi-touch action, across a display of an electronic device. That is, an electronic device configured to operate according to one or more embodiments of the present invention can determine whether a swipe action occurred, or whether a multi-touch action occurred, or it can determine between a swipe action and a multi-touch action.

In one embodiment, a method of determining a type of user input action on a display of an electronic device comprises vibrating a display on an electronic device, detecting variations in the vibrations caused by movement of a user's touch across a surface of the display, and determining whether the user performed at least one of a swipe action and a multi-touch action, based on the detected variations.

In one embodiment, vibrating the display comprises activating first and second haptic transducers on the display to generate standing waves to propagate across the display.

In one embodiment, detecting the variations caused by the movement of the user's touch across the surface of the display comprises detecting one or more sounds generated by the standing waves affected by the movement of the user's touch.

In one embodiment, determining whether the user performed at least one of a swipe action and a multi-touch action, comprises converting an amplitude for each of the detected one or more sounds into digitized signals, computing corresponding acoustic signatures for each of the amplitudes based on the digitized signals, and determining whether the user performed at least one of a swipe action and a multi-touch action, based on the computed acoustic signature.

In one embodiment, activating the first and second haptic transducers comprises individually activating the first and second haptic transducers to alternately operate in a driver mode to generate the standing waves, and a sensor mode to detect the variations caused by the movement of the user touch across the display.

In one embodiment, alternately activating the first and second haptic transducers comprises activating the first haptic transducer to operate in the driver mode to generate the standing waves, operating the second haptic transducer in the sensor mode, and detecting, at the second haptic transducer, the variations in the generated standing waves caused by the movement of the user's touch across the display.

In one embodiment, the method further comprises activating the second haptic transducer to operate in the driver mode to generate the standing waves, operating the first haptic transducer in the sensor mode, and detecting, at the first haptic transducer, the variations in the generated standing waves caused by the movement of the user's touch across the display.

In one embodiment, determining whether the user performed at least one of a swipe action and a multi-touch action, comprises receiving signals from each of the first and second haptic transducers operating in the sensor mode, the signals indicating amplitudes of the variations in the standing waves caused by the movement of the user's touch across the display, computing one or more power spectrum values for the variations based on the indicated amplitudes, and analyzing the one or more computed power spectrum values to determine whether the user performed at least one of a swipe action and a multi-touch action, across the display.

In one embodiment, detecting the variations caused by the movement of the user's touch across the display comprises detecting the variations at first and second sensors disposed on the display.

In one embodiment, the first and second sensors comprise first and second microphones.

In one embodiment, the first and second sensors comprise first and second first and second haptic transducers.

In one embodiment, detecting the variations in the vibrations caused by movement of a user's touch across a surface of the display comprises detecting the variations in the vibrations at a plurality of discrete times.

In one embodiment, detecting variations in the vibrations caused by movement of a user's touch across a surface of the display comprises detecting the variations in the vibrations at a plurality of time intervals.

The present invention also provides an electronic device comprising a display and a controller. In one embodiment, the controller is configured to vibrate the display, detect variations in the vibrations caused by movement of a user's touch across a surface of the display, and determine whether the user performed at least one of a swipe action and a multi-touch action, based on the detected variations.

In one embodiment, the electronic device further comprises first and second haptic transducers connected to the display, and wherein the controller is configured to control the first and second haptic transducers to generate standing waves that propagate through the display.

In one embodiment, the device further comprises first and second sensors disposed on the display opposite the first and second haptic transducers, respectively. The first and second sensors are, in this embodiment, configured to detect the variations caused by the movement of the user's touch across the surface of the display.

In one embodiment, the device further comprises first and second microphones connected to the display to detect one or more sounds caused by the movement of the user's touch across the surface of the display.

In one embodiment, the controller is further configured to receive signals from the first and second microphones indicating one or more amplitudes of the one or more sounds, compute corresponding acoustic signatures for the amplitudes based on the received signals, and determine whether the user performed at least one of a swipe action and a multi-touch action, based on the computed acoustic signatures.

In one embodiment, the controller is further configured to individually activate the first and second haptic transducers to alternately operate in a driver mode to generate the standing waves, and a sensor mode to detect the variations caused by the movement of the user's touch across the surface of the display.

In one embodiment, the controller is further configured to activate the first haptic transducer to operate in the driver mode to generate the standing waves across the display, operate the second haptic transducer in the sensor mode, and detect, at the second haptic transducer, the variations caused by the movement of the user's touch across the surface of the display.

In one embodiment, the controller is further configured to activate the second haptic transducer to operate in the driver mode to generate the standing waves in the display, operate the first haptic transducer in the sensor mode, and detect, at the first haptic transducer, the variations caused by the movement of the user's touch across the surface of the display.

In one embodiment, the controller is further configured to receive signals from each of the first and second haptic transducers indicating one or more amplitudes of the variations caused by the movement of the user's touch across the surface of the display, compute one or more power spectrum values for the variations based on the one or more amplitudes, and analyze the one or more computed power spectrum values to determine whether the user performed at least one of a swipe action and a multi-touch action, across the display.

In one embodiment, the controller is further configured to detect the variations in the vibrations at a plurality of discrete times.

In one embodiment, the controller is further configured to detect the variations in the vibrations at a plurality of discrete time intervals.

### BRIEF DESCRIPTION OF THE DRAWINGS

FIG. 1 is a perspective view illustrating an electronic device configured to operate according to one embodiment of the present invention.

FIG. 2 is a perspective view illustrating an electronic device configured to operate according to another embodiment of the present invention.

FIGS. 3A and 3B are cross-sectional views of a display surface configured to operate according to one embodiment of the present invention.

FIGS. 4A and 4B illustrate how the standing waves might propagate through a display if the user does not touch the display.

FIGS. 5A-5D illustrate how the standing waves might propagate through a display if the user performs a “swipe” action across the surface of the display screen.

FIGS. 6A-6D illustrate how the standing waves might propagate through a display if the user performs a “multi-touch” action across the surface of the display screen.

FIG. 7 is a flow chart illustrating a method of determining a type of user input action being performed by a user (e.g., swipe or multi-touch) according to one embodiment of the present invention.

FIG. 8 is a block diagram illustrating a circuit that may be used to control the operating modes of a transducer according to one embodiment of the present invention.

FIGS. 9A and 9B are perspective views of an electronic device configured to determine a type of user input action that is being performed by the user according to another embodiment of the present invention.

FIG. 10 is a flow chart illustrating a method of determining a type of user input action being performed by a user (e.g., swipe or multi-touch) according to another embodiment of the present invention.

FIG. 11 is a block diagram illustrating some of the components of an electronic device configured according to one embodiment of the present invention.

FIG. 12 is a perspective view of an electronic device configured to determine a type of user input action that is being performed by the user according to another embodiment of the present invention.

FIGS. 13A-13D illustrate how the standing waves might propagate through a display responsive to a user touch over a series of discrete time intervals.

FIG. 14 shows perspective views of some exemplary types of electronic devices suitable for use with the present invention.

### DETAILED DESCRIPTION

The present invention provides a device that can determine whether a user performed a “swipe” action or a “multi-touch” action on a display of an electronic device. As used herein, a “swipe” is defined as a user input action in which the user contacts the display with an object (e.g., a finger or a stylus), and then moves the object across a surface of the display from one discrete location on the display to another discrete location on the display without lifting the object from the surface of the display. For example, the movement of the object across the screen may be in a generally straight line or through an arcuate path. A “multi-touch” action is also defined as a user input action. However, with a “multi-touch” action, the user contacts the display in a plurality of distinct positions with a plurality of objects simultaneously (e.g., a forefinger and a thumb), and then moves those objects across the surface of the display without lifting the objects away from the surface of the display. With multi-touch, the movement of the objects may generally move along straight lines towards or away from each other, or through an arcuate path, for example.

The ability to detect the type of user action that is being performed is important because it allows a device to perform an appropriate function. For example, a user can move forward or backward through the images in a digital photo album being rendered on a display by “swiping” a forefinger across the display. When a desired image is located, the user might utilize a “multi-touch” action to resize the image. Particularly, the user may “pinch” a part of a display screen showing an image with a thumb and forefinger. Moving the fingers towards each other across the display decreases the size of the image, while moving the fingers away from each other across the display increases the size of the displayed image. By moving his or her finger or fingers through an arcuate path, the user can rotate an image on the display.

In one embodiment, the device includes a pair of haptic transducers that are connected to a display. Haptic transducers are typically employed to implement tactile feedback to the user. However, according to the present invention, they are momentarily activated whenever the user touches the display to generate standing waves in the display. The movement of a finger or fingers across the surface of the display, as is done when a user performs a “swipe” or “multi-touch” user input action, distorts these standing waves to produce unique variations in the standing waves. These distorted waves are then detected and measured by sensors on the display, and analyzed by a controller to determine whether the user performed at least one of a “swipe” action and a “multi-touch” action on the display.

In one embodiment, audible sound is produced when the user touches the display. The sound, which may or may not be audible to the human ear, is unique according to the particular modified standing waves and changes responsive to the type of user input action the user is performing. Therefore, the sensors that detect and measure the distortions may comprise a pair of microphones having a frequency response that is within the audible range of the human ear. In other embodiments, microphones or other devices having a sub-audible or super-audible frequency response are used as sensors.

Regardless whether the sound is or is not audible, however, the microphones that detect the sound generate signals that are digitized and sent to a controller. Based on the digitized signals, the controller computes one or more acoustic signatures for the detected sound or sounds. The acoustic signatures will vary in a predictable manner depending on the type of user input action the user performs (i.e., swipe or multi-touch). Therefore, the controller can analyze the acoustic signatures and determine whether the user is performing a swiping action, or a multi-touch action.

In another embodiment, the haptic transducers perform a dual function in that they first function as a vibrator to vibrate the display, and then as a sensor to detect the distortions to those vibrations. In this embodiment, a first haptic transducer is momentarily activated to generate the standing waves in the display. The second haptic transducer, however, is configured to sense the distortions caused by the user input action to those standing waves. Then, the roles of the transducers are reversed such that the second haptic transducer is momentarily activated to generate the standing waves in the display, and the first haptic transducer is configured to sense the distortions caused by the user input action to those standing waves. Each haptic transducer provides its sensor readings to the controller, which analyzes them to determine whether the user is performing a swipe action, or a multi-touch action.

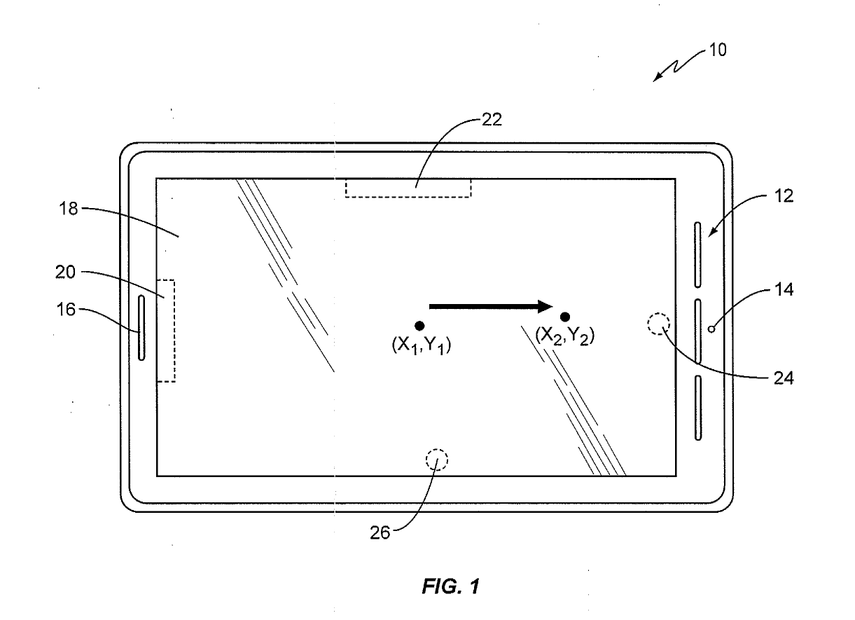

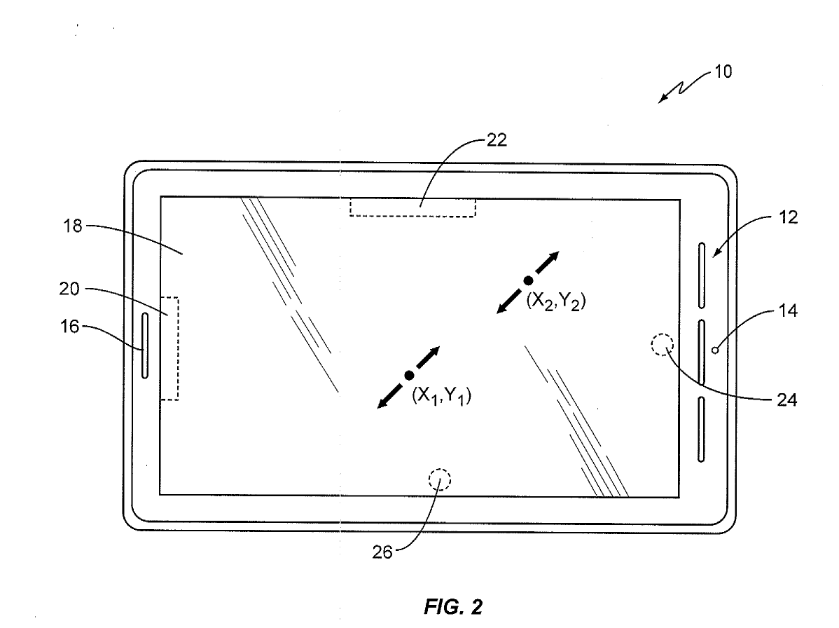

Turning now to the drawings, FIGS. 1 and 2 are perspective views illustrating the front face of a cellular telephone device 10 configured according to one embodiment of the present invention. Device 10 comprises, inter alia, a set of global controls 12 to enable a user to control the functionality of device 10, as well as a microphone 14 and a speaker 16 to allow the user to communicate with one or more remote parties via a wireless communication network (not shown). Device 10 also comprises a touch-sensitive display 18, first and second haptic transducers 20, 22, and a pair of sensors 24, 26, which in this embodiment comprises a pair of microphones. In one embodiment, the haptic transducers 20, 22 and the sensors 24, 26 are configured to detect certain user input actions performed by the user. One such action is a “swipe” action (FIG. 1), in which the user moves a finger across the surface of display 18 between two discrete locations (e.g., (x₁, y₁) and (x₂, y₂)), while maintaining contact with the surface of display 18. The other action is a “multi-touch” action such as a “pinch” (FIG. 2). With this type of action, the user contacts the display 18 surface with two or more digits simultaneously (e.g., a thumb and forefinger at locations (x₁, y₁) and (x₂, y₂), respectively), and moves them towards or away from each other while maintaining contact with the surface of display 18.

In more detail, display 18 in this embodiment comprises a touch-sensitive display that is configured to detect the user's touch at different locations on the display (e.g., (x₁, y₁) and (x₂, y₂)). The haptic transducers 20, 22 are positioned on the display 18 and along two perpendicular sides of display 18. The microphones 24, 26 are also placed on the display 18 along the other two perpendicular sides opposite the haptic transducers 20, 22. The exact positioning of the haptic transducers 20, 22 and of the microphones 24, 26 along the sides of display 18 are not critical; however, in one embodiment, microphone 24, 26 is displaced slightly inward from the edges of the display 18 toward the center of display 18. This placement allows the microphones 24, 26 to sufficiently detect the acoustic properties of the modified vibrations, and thus, more accurately determine whether a user is performing a swiping action or a multi-touch action.

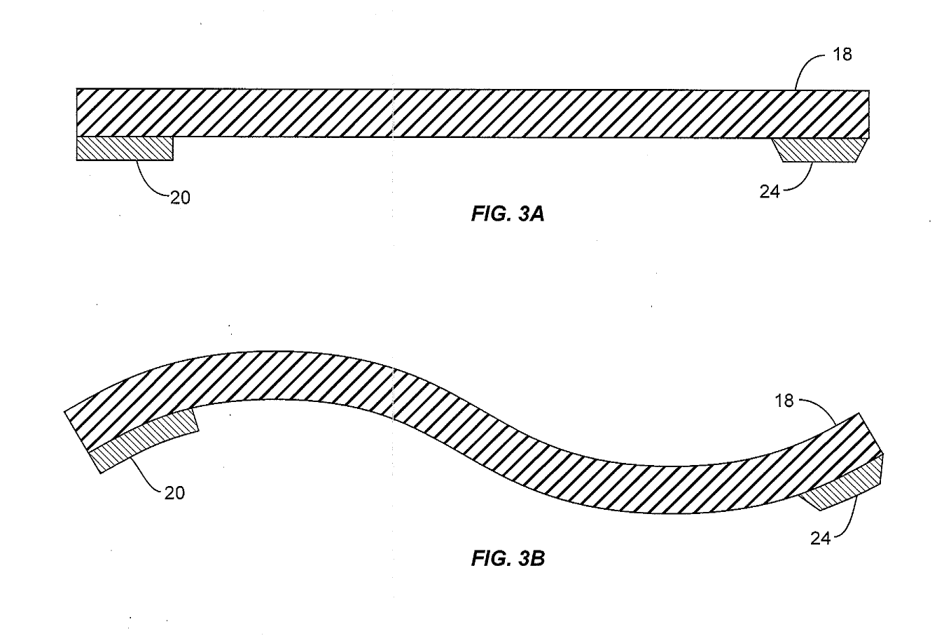

As previously stated, the haptic transducers 20, 22 are activated in response to the user's touch on display 18 to cause vibrations in the material of the display 18. FIGS. 3A-3B illustrate this aspect of the invention in more detail. Particularly, FIGS. 3A and 3B illustrate a cross sectional view of display 18 showing the haptic transducer 20 on one side and the corresponding microphone 24 on the other. Although only one haptic transducer 20 and microphone 24 is illustrated here, those skilled in the art will appreciate that this figure is merely illustrative of the operation of both haptic transducers 20, 22 and both microphones 24, 26.

In FIG. 3A, the user has not touched display 18 and as a result, display 18 is at rest (i.e., display 18 is not vibrating). However, as seen in FIG. 3B, the touch-sensitive display 18 generates a signal to a controller to momentarily activate both the first and second haptic transducers 20, 22 when the user touches the display 18 to perform a swipe or multi-touch action (e.g., at location (x₁,y₁) and/or (x₂, y₂) as seen in FIGS. 1-2). Particularly, the haptic transducers 20, 22 vibrate a surface of the display 18 to create standing waves in the surface of display 18. The haptic transducers 20, 22 generate the standing waves at a frequency f, commonly known as the “fundamental,” and at a plurality of multiples of the fundamental, commonly known as “harmonics.” As stated above, the different user input actions such as “swipe” and “multi-touch” actions, for example, uniquely distort or modify the standing waves. The microphones 24, 26, detect the sound of these modified standing waves, which vary in a predictable manner depending on the type of user touch input action.

More particularly, the distortions or modifications to the standing waves caused by the user input action differ based on the location(s) of the initial user touch(es) relative to the haptic transducers 20, 22, as well as on the intermediate and final location(s) of the user's touch(es) as the user's digit(s), or other object(s), slides across the surface of display 18. That is, a user's touch at an initial position on the display 18 that may be relatively near haptic transducer 20 (e.g., a position from where the user will begin a “swipe” action) will distort the standing waves differently than if the user had initially touched the display at another position farther away from the haptic transducer 20. Further, these distortions continue as the user moves his finger across the surface of the display 18 until the user finishes the swiping action by lifting his finger away from the surface of display 18. The microphones 24, 26 detect the sounds created as the user moves his finger along the surface of the display 18, and would generate different signals based on the different sounds. A similar scenario occurs for multi-touch actions. As such, the acoustic signatures of a given modified standing wave are unique for a swipe action between two locations, as well as for the multi-touch actions. This allows the controller in device 10 to determine whether the user has performed a swipe action or a multi-touch action.

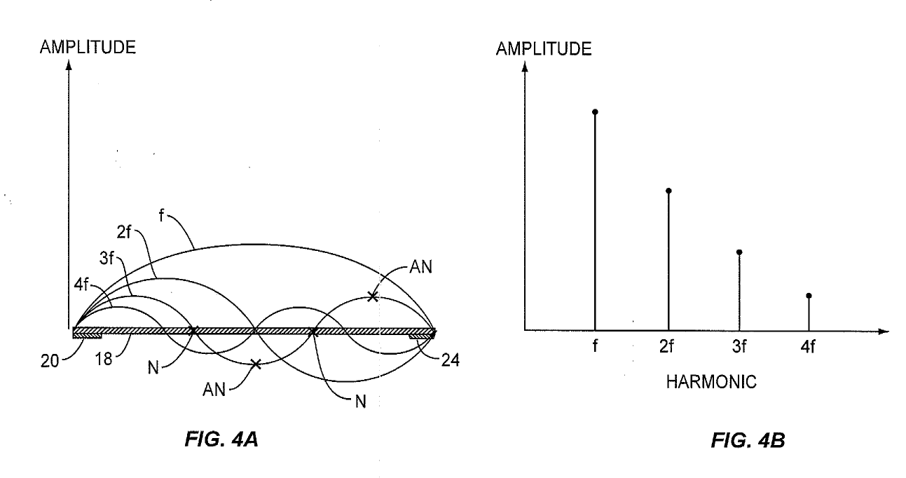

FIGS. 4-6 illustrate this aspect of the present invention in more detail. In some of these figures, the display 18 is seen along with the haptic transducer 20 and the microphone 24 for reference. Only the standing waves for the first four harmonic frequencies are shown in these figures. These are the first harmonic frequency or “fundamental” frequency f, the second harmonic frequency 2f (i.e., twice the fundamental), the third harmonic frequency 3f (i.e., three times the fundamental), and the fourth harmonic frequency 4f (i.e., four times the fundamental). Each standing wave has a node N (i.e., the point of a wave having minimal amplitude) and an anti-node AN (i.e., the point of a wave having maximum amplitude), although for illustrative purposes, the node N and the anti-node AN for only some of those waves are shown. Note that while four harmonics are shown in the figures, a larger number may be present in some embodiments.

FIG. 4A illustrates the standing waves generated by the haptic transducer 20 along a longitudinal axis of display 18 as they might appear if no finger or stylus touches display 18. FIG. 4B is a corresponding graph illustrating the amplitudes of the first four harmonic frequencies f, 2f, 3f, 4f as they might appear if no user touches the display 18. As seen in FIG. 4B, each harmonic frequency f, 2f, 3f, 4f has a different amplitude.

Since the frequency causing the standing waves in display 18 is known, the amplitudes for each wave are readily measurable. Further, the user's touch will disturb these waves in predictable ways as the user moves a finger or fingers, for example, across the surface of display 18 such that a unique modified wave is generated for any given location along the path of movement. According to this embodiment of the present invention, the sound(s) of the unique modified standing wave(s) that are caused by the user input action (e.g., swipe or multi-touch) can be analyzed to determine the type of user action the user input action is performing.

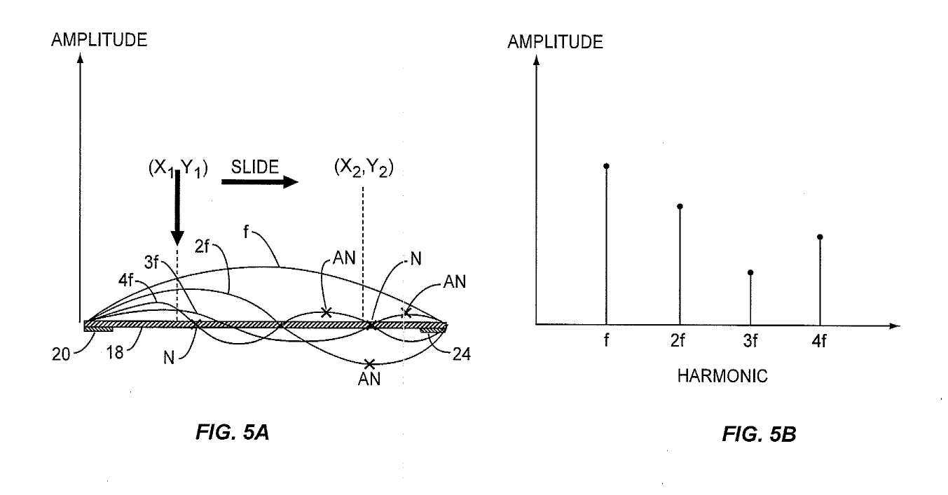

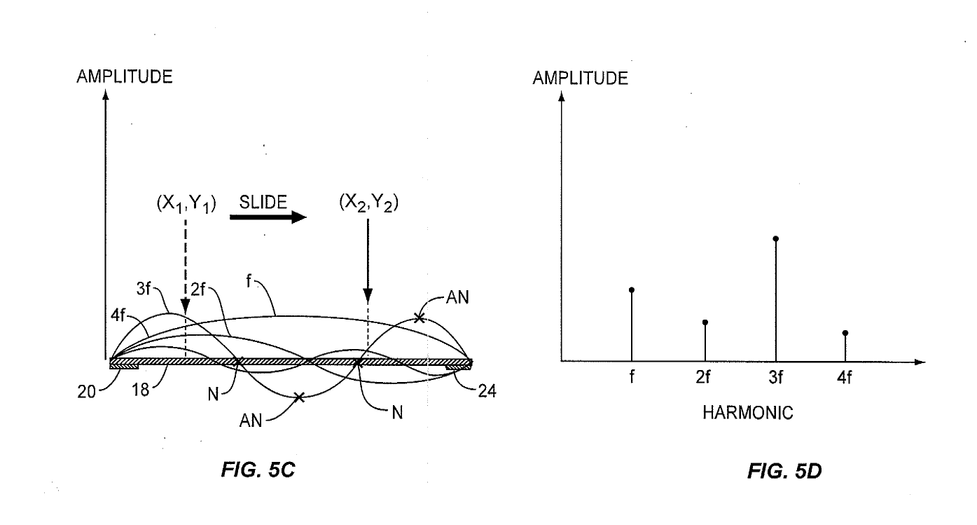

For example, FIGS. 5A-5D illustrate the effects of a user swipe action on the generated standing waves if the user begins the swipe at position (x₁,y₁) on the display 18 pointed to by the arrow (i.e., FIGS. 5A-5B), and ends at position (x₂, y₂) (i.e., FIGS. 5C-5D). As seen in FIGS. 5A-5B, the user's initial touch at position (x₁, y₁) on display 18 reduces the amplitudes of the standing waves for the harmonic frequencies 2f, 3f, and 4f. However, the amplitude for the first harmonic frequency f is not as greatly affected due to the location of the user touch. Specifically, one or more of the amplitudes are reduced depending upon how near, or how far, the touch location is from the nodes N of the harmonic frequencies. Using the first harmonic f as an example, user touches that occur at a location on display 18 nearest a node N for a given harmonic frequency will reduce the amplitude of that standing wave less than if the touch had occurred nearer an anti-node AN of that harmonic frequency. At the end of the swipe action (FIGS. 5C-5D), the user's finger touches a final position (x₂, y₂) on display 18, which reduces the amplitudes of the standing waves for the harmonic frequencies f, 2f, and 4f.

The distortions to the standing waves therefore change as the user slides his finger or stylus across the surface of display 18 from an initial position (x₁, y₁) towards an ending position (x₂, y₂). This is due to the changing position of the user's finger relative to the nodes N and anti-nodes AN of the harmonic frequencies, and it creates a unique set of acoustic signatures between the start and the end of the swipe action. The controller in device 10 can analyze these particular acoustic signatures and determine whether the user is performing swipe action across the surface of display 18.

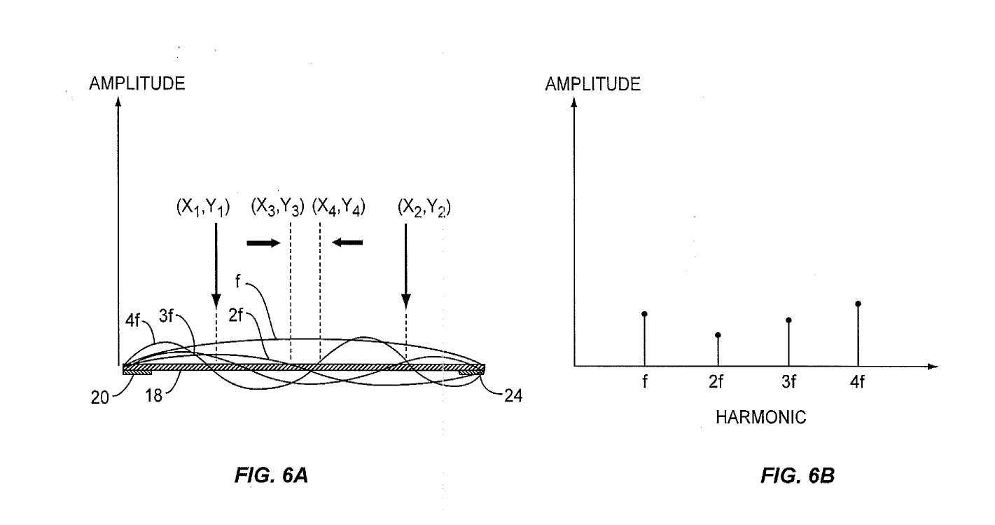

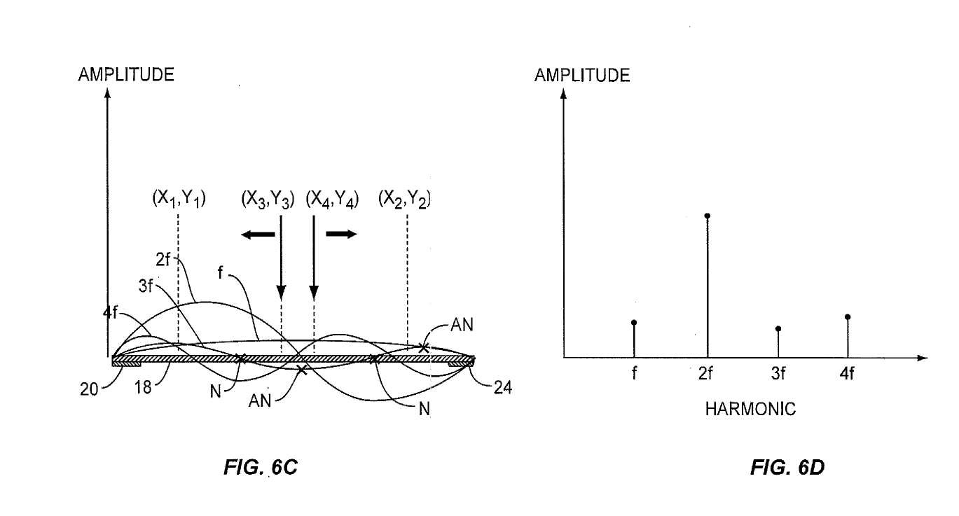

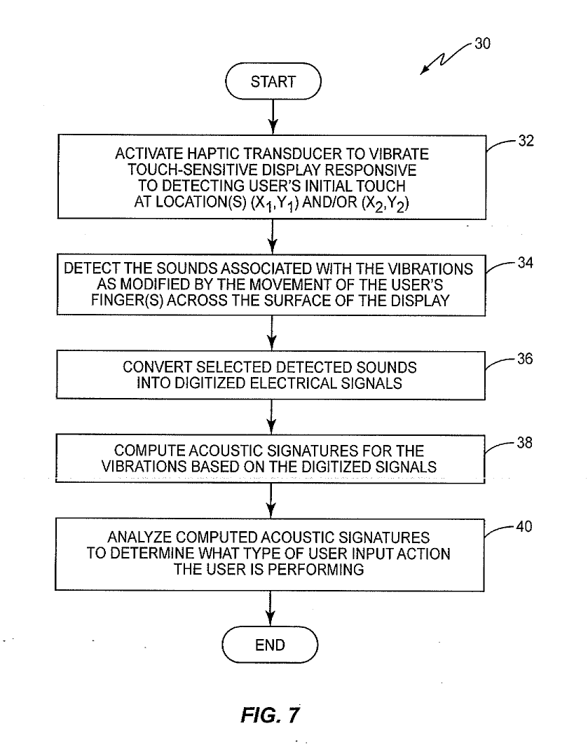

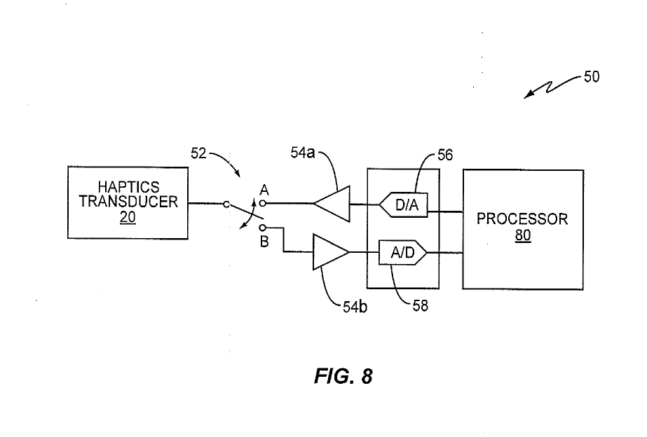

FIGS. 6A-6D illustrate the effects of performing a multi-touch user action on the generated standing waves if the user initially places a thumb and forefinger at positions (x₁,y₁) and (x₂, y₂) on the display 18, respectively, and moves them together in a “pinching” motion towards positions (x₃, y₃) and (x₄, y₄). As seen in FIGS. 6A-6B, the user's initial touches at positions (x₁, y₁) and (x₂, y₂) on display 18 reduces the amplitudes of the standing waves for the harmonic frequencies f and 2f. However, the amplitude for harmonic frequencies 3f and 4f are not as greatly affected. As above, one or more of the amplitudes are reduced depending upon how near, or how far, the touch locations are from the nodes N of the harmonic frequencies. At the end of the “pinching” motion (FIGS. 6C-6D), the user's thumb and forefinger are touching different positions on display 18 (x₃, y₃) and (x₄, y₄), which reduces the amplitudes of the standing waves for the harmonic frequencies f and 3f, but leave the standing waves for harmonic frequencies 2f and 4f less affected. As with the “swiping” action described above, the movement of the user's thumb and forefinger between the positions (x₁, y₁), (x₂, y₂) and (x₃, y₃), (x₄, y₄) will create a unique set of acoustic signatures that can be analyzed by the device 10 to determine whether the user has performed a “multi-touch” user input action.

FIG. 7 is a flow diagram illustrating a method 30 of performing one embodiment of the present invention. Method 30 begins when, upon detecting the user's initial touch on display 18 at a location (e.g., x₁, y₁ and/or x₂, y₂, depending upon the type of user action being performed), the device 10 activates the first and second haptic transducers 20, 22 to vibrate the touch-sensitive display 18 (box 32). This causes the standing waves to propagate through display 18, which are modified in a known manner based on the movement of the user's finger(s) across the surface of display 18. The microphones 24, 26 disposed on the display 18 detect the sound(s) that are associated with these modified standing waves and caused by the movement across the display 18 (box 34). The microphones 24, 26 then send analog signals indicating the amplitude of the detected sound(s) to processing circuitry for conversion into digitized electrical signals. The digitized electrical signals are then sent to a controller or other processor in device 10 (box 36).

It should be noted that the device need not send a continuous stream of signals for every location the user touches while moving his finger(s) across the display. Rather, the sounds need only be detected and converted into electrical signals periodically. For example, in one embodiment, only the sounds created by placing the user's finger(s) at the initial and final positions on display 18 are converted and used in the process. In other embodiments, the microphones 24, 26 also capture one or more sounds corresponding to the position(s) of the user's digit(s) at intermediate locations along the path of movement. There is no limit as to the number of locations at which the sounds may be detected and used in the present invention.

Upon receipt of the digitized electrical signals, the controller determines the type of user input action that is being performed based on the digitized signals. As described in more detail later, the type of user action (e.g., swipe or multi-touch) may be determined in different ways; however in at least one embodiment, the controller computes acoustic signatures for each of the sound(s) generated by the modified standing waves based on the digitized electrical signals (box 38), and analyzes the computed acoustic signatures to determine the type of user input action that the user is performing (box 40).

Determining the type of user input action in accordance with the present invention provides benefits that conventional methods cannot provide. For example, with the present invention, the haptic transducers 20, 22, the microphones 24, 26, and the other resources that detect the user's digits as they across the display 18 are activated only when a user initially touches the display 18. For example, the display 18 may be configured to sense pressure, a change in resistance, or measure an amount of reflected light to determine when a user is touching display 18. Display 18 does not need to be continually active to monitor for user touches, as is required by conventional devices that use a passive approach. Thus, a device using the active approach of the present invention consumes less power than do other conventional devices. Further, the method of the present invention relies on the acoustic signatures of the modified standing waves, which are caused by the user moving a finger or fingers across the surface of display 18. As such, the amount of force with which a user touches the display 18 has a minimal effect on the ability of a controller to determine the type of user input touch a user is performing.

Another benefit results from the manner in which the type of user input action is computed from the modified amplitudes. Specifically, any location on display 18 between the start and end positions can easily be computed using known mathematical processes to interpret the unique acoustical signatures of the modified standing waves. Thus, there is no need in the present invention to determine exact locations for the placement of the microphones 24, 26 on display 18, as must be done for conventional devices using a passive acoustic approach. This reduces the impact of the unique mechanical design aspects required by conventional devices.

The use of microphone 24, 26 as sensors is only one embodiment. FIGS. 8-10 illustrate another embodiment of the present invention that does not require microphones 24, 26 as sensors. Instead, with this embodiment, each haptic transducer 20, 22 performs a dual function. Particularly, each haptic transducer 20, 22 is first used actively as a driver (i.e., in a “driver mode”) to generate the standing waves in display 18, and then passively as a sensor (i.e., in a “sensor mode”) to detect the distortions or modifications of the standing waves that are caused by the user's touch. Switching the haptics transducers 20, 22 between these two operating modes may be accomplished using any means known in the art. However, in one embodiment seen in FIG. 8, device 10 utilizes a mode switching circuit 50 to switch haptic transducer 20 between the “driver mode” and the “sensor mode.”

Circuit 50 comprises a switch 52 that alternately connects and disconnects the haptics transducer 20 to a pair of amplifiers 54a, 54b. A Digital-to-Analog (D/A) converter 56 converts digital signals from controller 80 into analog signals for the haptics transducer 20, while an Analog to Digital (A/D) 58 converts analog signals from the haptics transducer 20 into digital signals for the controller 80. The controller 80, which is described in more detail later, performs the calculations necessary to determine the type of user input action that is being performed on display 18, and generates control signals to operate switch 52 to switch the mode of the haptics transducer 20 between a driver mode and a sensor mode.

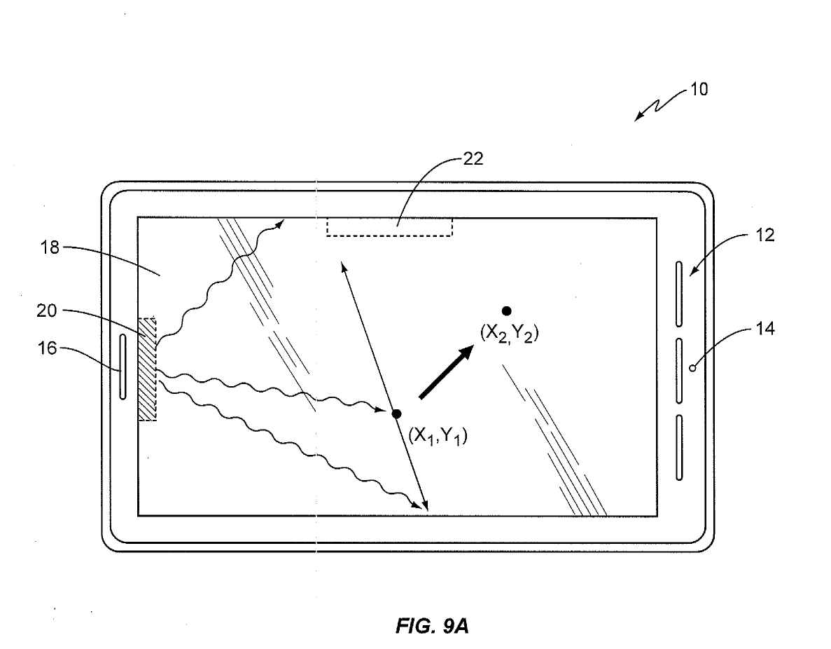

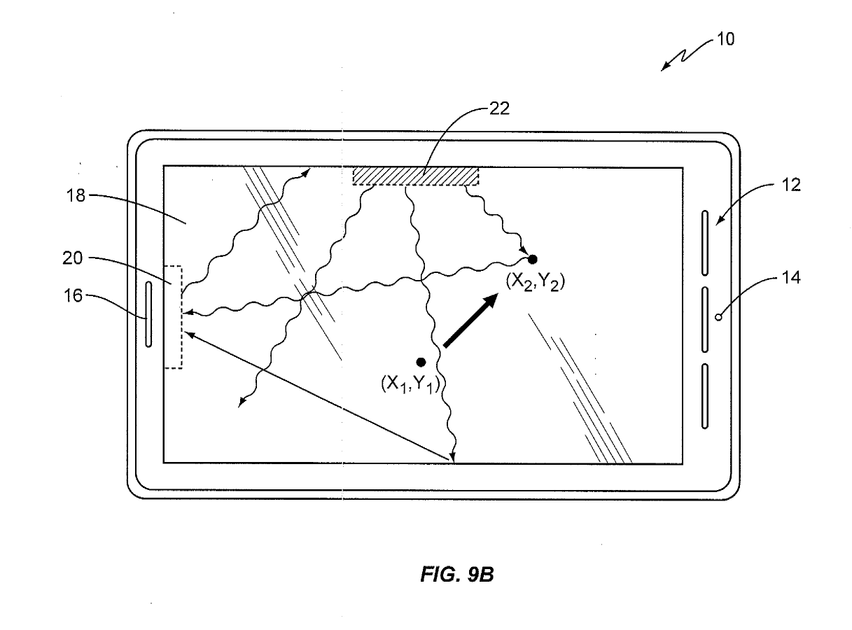

FIGS. 9A-9B illustrate this embodiment in more detail in the context of a “swipe” user input action. As seen in FIG. 9A, device 10 momentarily activates a first one of the haptic transducers 20 in a driver mode to vibrate display 18 responsive to detecting the user's initial touch at location (x₁,y₁). The other haptic transducer 22 is left in a sensor mode to passively sense the amplitudes of the modified standing waves. Then, as seen in FIG. 9B, the roles of the haptic transducers 20, 22 are reversed. That is, device 10 momentarily activates the other haptic transducer 22 in the driver mode to vibrate the display 18 and switches the first haptic transducer 20 to the sensor mode so that it can sense the resultant amplitudes of the modified standing waves when the user's finger reaches position (x₂, y₂). As above, the standing waves are modified in a predictable manner depending upon the location of the user's finger relative to the nodes N and the anti-nodes AN of the modified standing waves. Based on the information provided by haptic transducers 20, 22 when in the sensor mode, a controller 80 in device 10 can accurately determine whether a user is performing a “swipe” action across the display 18, or whether the user is performing some other user input action.

Although FIGS. 9A-9B describe an embodiment in the context of detecting a “swipe” user input action, alternately operating the first and second transducers in a driver mode and a sensor mode may also be used to determine if the user is performing a multi-touch input action. Particularly, since the different movements are associated with different touch locations across the display, the controller can determine the type of movement based on the resultant modifications to the vibrations in the surface of the display 18.

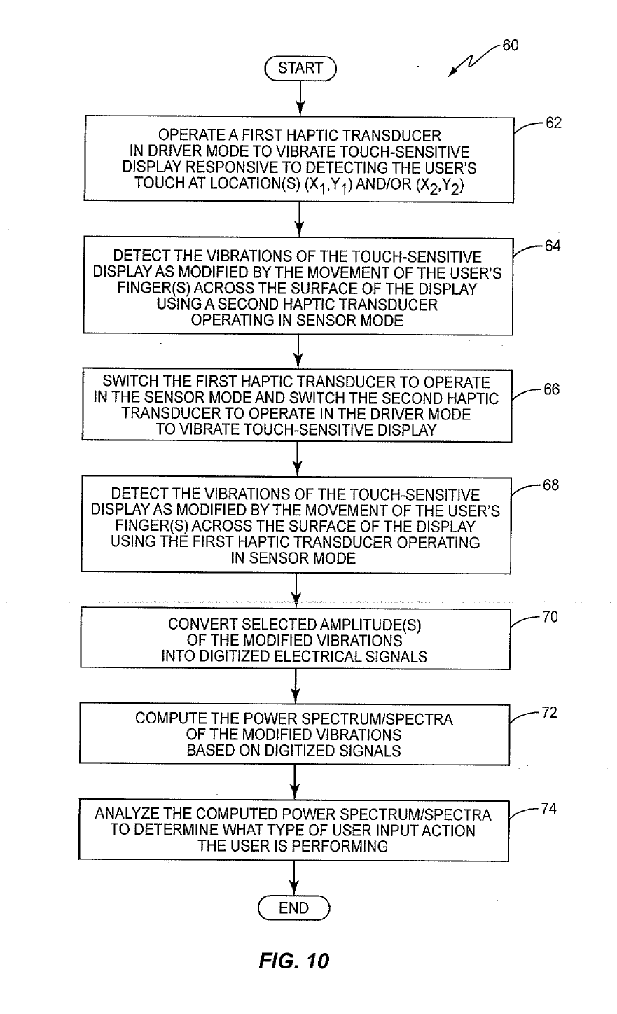

FIG. 10 is a flow chart that illustrates a method 60 of determining the type of input action a user is performing on device 10 using the haptic transducers 20, 22 in alternating driver and sensor modes. Method 60 begins with device 10 momentarily activating first haptic transducer 20 in the driver mode responsive to detecting the user's touch (box 62). The user's touch May be detected at any location on display 18, and may be at a single location, such as when the user begins a “swipe” movement, or at multiple locations, such as when the user begins a “multi-touch” movement. As the first haptic transducer 20 vibrates the display 18, the second haptic transducer 22 is switched to operate in the sensor mode. This allows the second haptic transducer 22 to detect the amplitudes of the standing waves generated by the first haptic transducer 20 as they are modified by the movement of the user's finger(s) across the surface of display 18 (box 64). Next, the device 10 switches the first haptic transducer 20 to sensor mode and momentarily switches the second haptic transducer 22 to driver mode (box 66). While in driver mode, the second haptic transducer 22 generates the standing waves in display 18 while the first haptic transducer 20 operating in sensor mode detects the amplitudes of the resultant modified standing waves in display 18 (box 68).

While in the sensor mode, each haptic transducer 20, 22 provides analog signals to the A/D converter 58 representing the detected amplitudes of the modified standing waves. The A/D converter 58 converts these signals into digitized electrical signals for the controller 80 (box 70). Controller 80 then computes the power spectrum (or spectra) of the modified vibrations based on the digitized electrical signals (box 72), and determines the type of user input action that is being performed based on those computations (box 74).

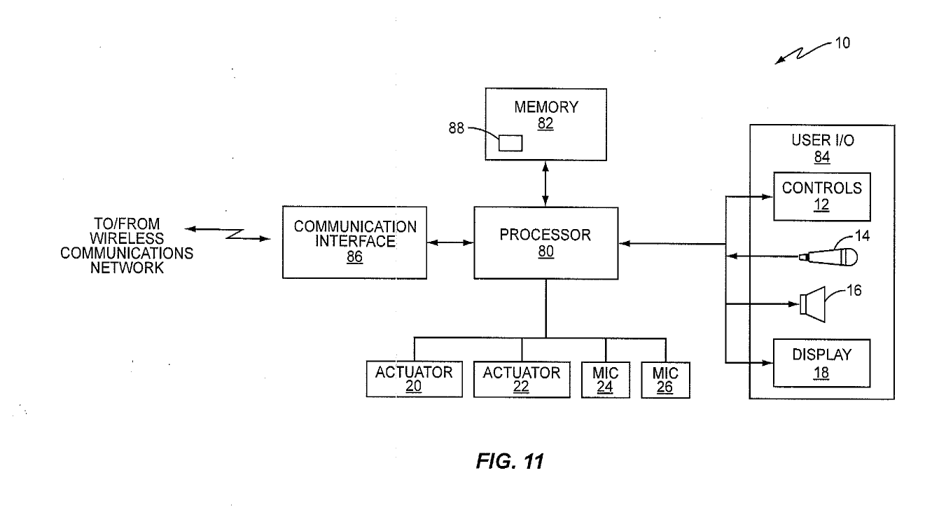

FIG. 11 is a block diagram illustrating some of the components of an electronic device 10 configured according to one embodiment of the present invention. Device 10 comprises a programmable controller 80, a memory 82, a user input/output interface 84, and a communications interface 88. As previously stated, device 10 also comprises a pair of haptic transducers 20, 22 and a pair of sensors 24, 26, which are indicated as microphones in the embodiment of FIG. 11.

Controller 80 generally controls the overall operation of device 10 according to programs and instructions stored in memory 82. The controller 80 may comprise a single microprocessor or multiple microprocessors executing firmware, software, or a combination thereof. The microprocessors may be general purpose microprocessors, digital signal processors, or other special purpose processors, and may further comprise special-purpose fixed or programmable logic or arithmetic units. The controller 80 is programmed to receive signals from the sensors 24, 26 (i.e., either the haptic transducers 20, 22 or the microphones), and analyze the signals to determine the type of input action a user is performing (e.g., swipe or multi-touch) as the user moves his/her finger(s) across the surface of display 18.

Memory 82 comprises a computer-readable medium that may include both random access memory (RAM) and read-only memory (ROM). Although not specifically shown, those skilled in the art will appreciate that the memory 82 may be embodied other hardware components, such as compact disks (CDs), hard drives, tapes, and digital video disks (DVDs) that may be connected to the device 10 via an interface port (not shown). Computer program instructions and data required for operation are stored in non-volatile memory, such as EPROM, EEPROM, and/or flash memory, which may be implemented as discrete devices, stacked devices, or integrated with the controller 80. One such computer program, indicated here as application 88, allows the controller 80 to function according to one or more embodiments of the present invention. Particularly, application 88 contains computer program instructions that, when executed by controller 80, causes the controller 80 to react to the detected user's touch by activating and deactivating the haptic transducers 20, 22 and/or microphones 24, 26, as well as analyzing the resultant signals received from those sensors to determine whether the user is performing a swipe input action, a multi-touch input action, or some other input action requiring contact between the user and the surface of display 18.

The User Interface (UI) 84 includes one or more user input/output devices, such as a touch-sensitive display 18, a microphone 14, a speaker 16, and one or more global controls 12 to enable the user to interact with and control device 10. The communication interface 86 allows the device 10 to communicate messages and other data with one or more remote parties and/or devices. In this embodiment, the communication interface 86 comprises a fully functional cellular radio transceiver that can operate according to any known standard, including the standards known generally as the Global System for Mobile Communications (GSM), the General Packet Radio Service (GPRS), cdma2000, Universal Mobile Telecommunications System (UMTS), Wideband Code Division Multiple Access (WCDMA), 3GPP Long Term Evolution (LTE), and Worldwide Interoperability for Microwave Access (WiMAX). In other embodiments, however, the communication interface 86 may comprise a hardware port, such as an Ethernet port, for example, that connects device 10 to a packet data communications network. In yet another embodiment, the communication interface 86 may comprise a wireless LAN (802.11x) interface.

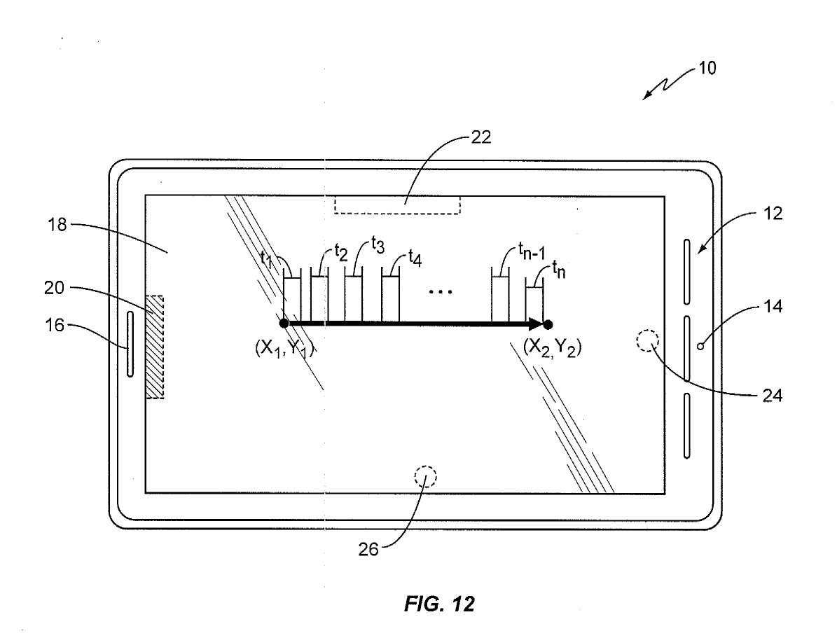

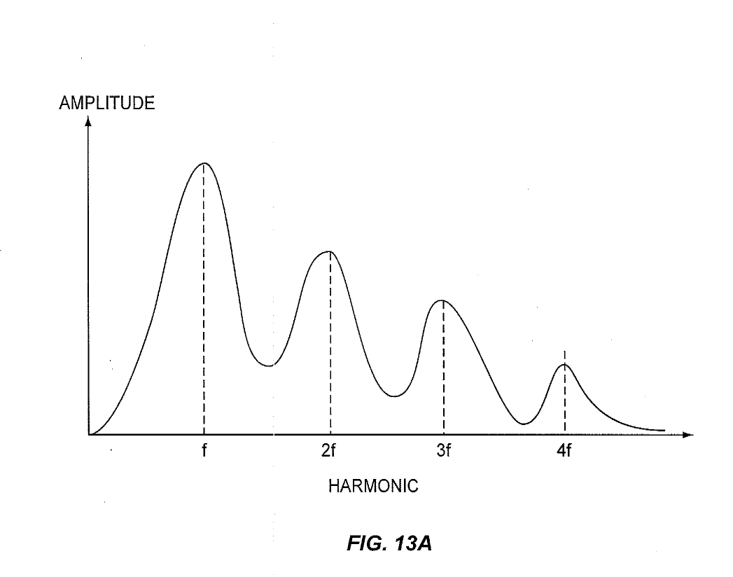

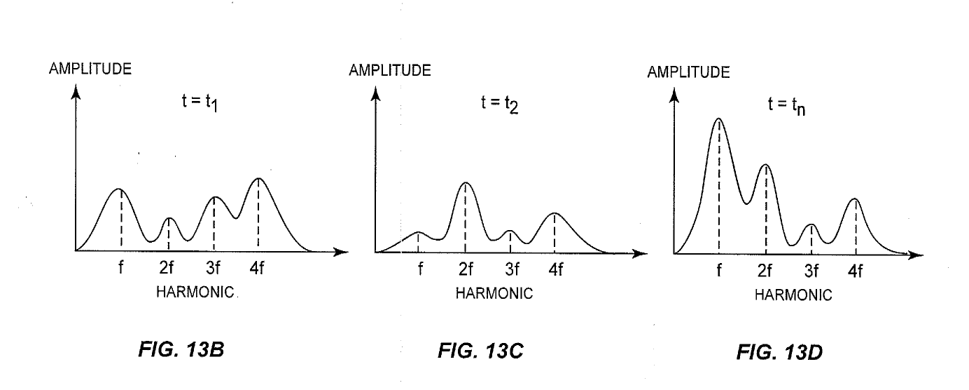

The present invention may, of course, be carried out in other ways than those specifically set forth herein without departing from the essential characteristics of the invention. For example, the previous embodiments described a method of determining a type of user input action by analyzing the variations in the vibrations caused by the movement of a user's touch across a surface of the display. More particularly, the controller 80 computes acoustic signatures for each of the sound(s) generated by the modified standing waves at one or more discrete points in time. The controller 80 then analyzes the computed acoustic signatures to determine the type of user input action that the user is performing. In another embodiment, seen in FIGS. 12-13, the controller 80 is configured to compute the acoustic signatures of each of the generated sound(s) over a plurality of discrete time intervals t.

As seen in FIG. 12, the user performs a swipe action by touching the display 18 and moving a finger from one point (x₁, y₁) to another point (x₂, y₂) across the surface of display 18. As in the previous embodiments, the haptic transducers 20, 22 are momentarily activated to vibrate the display 18. The movement of the user's finger across the surface of display 18 distorts the standing waves in a predictable manner, and the sound(s) generated by the distorted waves are detected by microphones 24, 26. However, rather than sample the modified waves at discrete points in time, which produces results such as those seen in FIGS. 4-6, this embodiment of the present invention samples the modified standing waves over a plurality of discrete time intervals t₁ . . . tₙ. The controller 80 may perform any number of samples needed or desired, and each time interval may be any desired length of time. However, in one embodiment, about 100 samples are taken by controller 80, with each sample being taken over a time interval t that is about 10 msecs long.

The controller 80 will sample the modified standing waves over each interval t₁ . . . tₙ for a total time T, which is the total length of time needed for the user's finger to travel across the surface of display 18 (i.e., the length of time of the swipe action). The controller 80 then uses a Discrete Fourier Transform (DFT) to produce a continuous spectrum for each time interval t₁ . . . tₙ. The controller 80 compares these generated spectra to spectra stored in memory and, based on comparison, determines whether the user is performing a “swipe” action, as seen in FIG. 12, or some other multi-touch action.

For example, FIGS. 13A-13D illustrate the effects of a user swipe action on the generated standing waves if the user begins the swipe at position (x₁,y₁) on the display 18 and ends at position (x₂, y₂). More particularly, FIG. 13A is a graph illustrating the amplitudes of the first four harmonic frequencies f, 2f, 3f, 4f as they might appear when the user is not touching the display 18. Each harmonic frequency f, 2f, 3f, 4f has a different amplitude. As the user moves his finger across the surface of display 18, the controller 80 samples the modified waves over a plurality of discrete time intervals t₁ . . . tₙ.

FIG. 13B illustrates a graph of a sample taken over time interval t₁ beginning with the user's initial touch at position (x₁, y₁) on display 18. As the user moves his finger across display 18 during t₁, the movement reduces, to varying degrees, the amplitudes of the standing waves for the harmonic frequencies f, 2f, and 3f. However, the amplitude for the fourth harmonic frequency 4f is not as greatly affected due to the location of the user touch (i.e., how near, or how far, the touch location is from the nodes N of the harmonic frequencies). As seen in FIG. 13C, this changes over time interval t₂. Particularly, because the user's finger moves across the display 18 at a different set of locations, the amplitudes of the second and fourth harmonic frequencies 2f and 4f are relatively unaffected while the amplitudes for the other frequencies f and 3f are more greatly affected. Towards the end of the swipe action, tₙ, the user's finger is moving toward the final position (x₂, y₂) on display 18. The movement over the surface of display 18 during this time interval reduces the amplitudes of the standing waves for the harmonic frequencies 3f while leaving the other amplitudes for the other harmonic frequencies.

The distortions to the standing waves therefore change as the user slides his finger or stylus across the surface of display 18 from an initial position (x₁, y₁) towards an ending position (x₂, y₂). The controller 80 samples these particular acoustic signatures across a predetermined number of discrete time intervals, and uses the resultant continuous harmonic spectra to determine whether the user is performing swipe action across the surface of display 18, or some other user input action such as a multi-touch action.

In addition to the microphones, the present invention may utilize the haptic transducers 20, 22 in an alternating driver/sensor mode, as previously described, and sample the modified vibrations caused by the movement of the user's finger across the display 18 over the plurality of discrete time intervals t₁ . . . tₙ. In this embodiment, the controller 80 would simply alternately operate each haptic transducer 20, 22 in the sensor mode for a time interval t so that it could gather information about the movement of the user's finger as previously described. For example, during time interval t₁, haptic transducer 20 would operate in the driver mode, while haptic transducer 22 would operate in the sensor mode. During time interval t₂, haptic transducer 22 would operate in the driver mode, while haptic transducer 20 would operate in the sensor mode. This alternating between modes and time intervals t would continue until the user input action ceases. As above, the controller 80 would perform a DFT analysis for each time interval t, and compare the captured acoustic signatures to a table of predetermined acoustic signatures to determine whether the user is performing a swipe or multi-touch user input action.

Further, the present invention may also, in one embodiment, be configured to utilize the the leading edges of both the modified standing waves as well as the “echos” of the standing waves to determine additional information about the user input action. Particularly, the haptic transducers 20, 22 generate the vibrations through the surface of display 18. These vibrations may reflect off of the walls of the display 18, for example, and then intersect with the user's finger at various locations as the user's finger moves across the surface of display 18. The sensors (e.g., either the microphones 24, 26 or the haptic transducers 20, 22 themselves, depending on the embodiment), detect the leading edges of the modified vibrations and perform the analysis previously described over the time intervals t₁ . . . tₙ to determine whether the user is performing a swipe action or a multi-touch action.

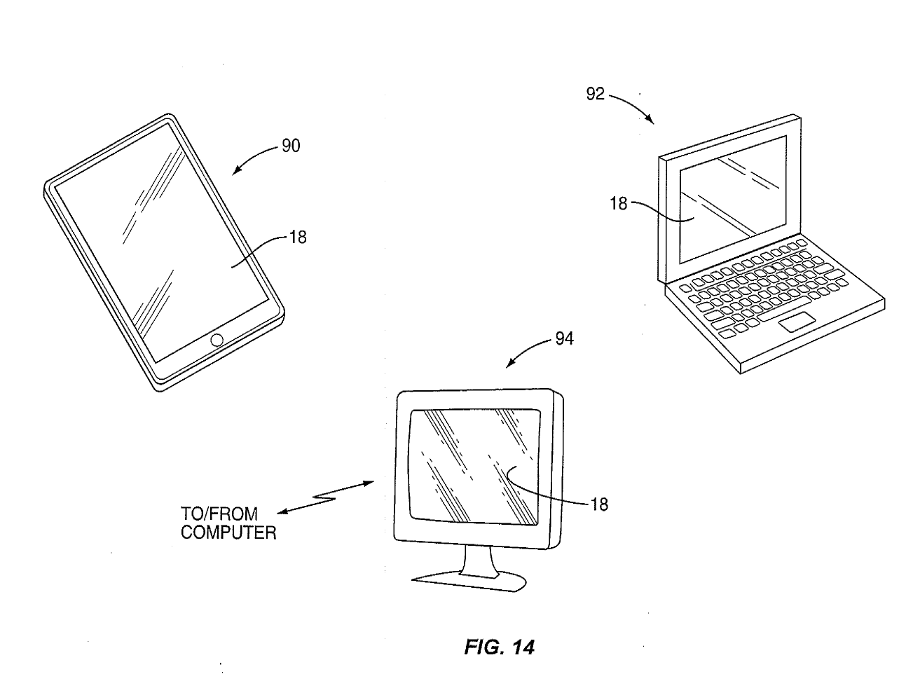

The previous embodiments describe the present invention in terms of the device 10 being a cellular telephone, and more particularly, a smartphone. However, the present invention is not so limited. In other embodiments, seen in FIG. 14, for example, device 10 comprises a tablet computing device, such as APPLE'S iPAD 90, or a personal computing device 92, such as a laptop or desktop computer, or a display device 94 connected to a server or other computing device.

Additionally, the display 18 has been described in the previous embodiments as being a touch-sensitive display. However, those skilled in the art should appreciate that a touch-sensitive display is not necessary. All that is needed is some way to indicate that a user has touched the display. For example, the display 18 could comprise a Liquid Crystal Display, and the device could include a control button on the side of the housing. The user could activate/deactivate the haptic transducers by manually actuating the button, for example. Therefore, the present embodiments are to be considered in all respects as illustrative and not restrictive, and all changes coming within the meaning and equivalency range of the appended claims are intended to be embraced therein.

What is claimed is:

1. A method of determining a type of user input action on a display of an electronic device, the method comprising:
vibrating a display on an electronic device;
detecting variations in the vibrations caused by movement of a user's touch across a surface of the display; and
determining whether the user performed at least one of a swipe action and a multi-touch action, based on the detected variations.

2. The method of claim 1 wherein vibrating the display comprises activating first and second haptic transducers on the display to generate standing waves to propagate across the display.

3. The method of claim 2 wherein detecting the variations caused by the movement of the user's touch across the surface of the display comprises detecting one or more sounds generated by the standing waves affected by the movement of the user's touch.

4. The method of claim 3 wherein determining whether the user performed at least one of a swipe action and a multi-touch action, comprises:
converting an amplitude for each of the detected one or more sounds into digitized signals;
computing corresponding acoustic signatures for each of the amplitudes based on the digitized signals; and
determining whether the user performed at least one of a swipe action and a multi-touch action, based on the computed acoustic signature.

5. The method of claim 2 wherein activating the first and second haptic transducers comprises individually activating the first and second haptic transducers to alternately operate in a driver mode to generate the standing waves, and a sensor mode to detect the variations caused by the movement of the user touch across the display.

6. The method of claim 5 wherein alternately activating the first and second haptic transducers comprises:
activating the first haptic transducer to operate in the driver mode to generate the standing waves;
operating the second haptic transducer in the sensor mode; and
detecting, at the second haptic transducer, the variations in the generated standing waves caused by the movement of the user's touch across the display.

7. The method of claim 6 further comprising:
activating the second haptic transducer to operate in the driver mode to generate the standing waves;
operating the first haptic transducer in the sensor mode; and
detecting, at the first haptic transducer, the variations in the generated standing waves caused by the movement of the user's touch across the display.

8. The method of claim 7 wherein determining whether the user performed at least one of a swipe action and a multi-touch action, comprises:
receiving signals from each of the first and second haptic transducers operating in the sensor mode, the signals indicating amplitudes of the variations in the standing waves caused by the movement of the user's touch across the display;
computing one or more power spectrum values for the variations based on the indicated amplitudes; and
analyzing the one or more computed power spectrum values to determine whether the user performed at least one of a swipe action and a multi-touch action, across the display.

9. The method of claim 2 wherein detecting the variations caused by the movement of the user's touch across the display comprises detecting the variations at first and second sensors disposed on the display.

10. The method of claim 9 wherein the first and second sensors comprise first and second microphones.

11. The method of claim 9 wherein the first and second sensors comprise first and second first and second haptic transducers.

12. The method of claim 1 wherein detecting variations in the vibrations caused by movement of a user's touch across a surface of the display comprises detecting the variations in the vibrations at a plurality of discrete times.

13. The method of claim 1 wherein detecting variations in the vibrations caused by movement of a user's touch across a surface of the display comprises detecting the variations in the vibrations at a plurality of time intervals.

14. An electronic device comprising:
a display; and
a controller configured to:
vibrate the display;
detect variations in the vibrations caused by movement of a user's touch across a surface of the display; and
determine whether the user performed at least one of a swipe action and a multi-touch action, based on the detected variations.

15. The device of claim 14 further comprising first and second haptic transducers connected to the display, and wherein the controller is configured to control the first and second haptic transducers to generate standing waves that propagate through the display.

16. The device of claim 15 further comprising first and second sensors disposed on the display opposite the first and second haptic transducers, respectively, and configured to detect the variations caused by the movement of the user's touch across the surface of the display.

17. The device of claim 15 further comprising first and second microphones connected to the display to detect one or more sounds caused by the movement of the user's touch across the surface of the display.

18. The device of claim 17 wherein the controller is further configured to:
receive signals from the first and second microphones indicating one or more amplitudes of the one or more sounds;
compute corresponding acoustic signatures for the amplitudes based on the received signals; and
determine whether the user performed at least one of a swipe action and a multi-touch action, based on the computed acoustic signatures.

19. The device of claim 15 wherein the controller is further configured to individually activate the first and second haptic transducers to alternately operate in a driver mode to generate the standing waves, and a sensor mode to detect the variations caused by the movement of the user's touch across the surface of the display.

20. The device of claim 19 wherein the controller is further configured to:
activate the first haptic transducer to operate in the driver mode to generate the standing waves across the display;
operate the second haptic transducer in the sensor mode; and
detect, at the second haptic transducer, the variations caused by the movement of the user's touch across the surface of the display.

21. The device of claim 20 wherein the controller is further configured to:
activate the second haptic transducer to operate in the driver mode to generate the standing waves in the display;
operate the first haptic transducer in the sensor mode; and
detect, at the first haptic transducer, the variations caused by the movement of the user's touch across the surface of the display.

22. The device of claim 21 wherein the controller is further configured to:
receive signals from each of the first and second haptic transducers indicating one or more amplitudes of the variations caused by the movement of the user's touch across the surface of the display;
compute one or more power spectrum values for the variations based on the one or more amplitudes; and
analyze the one or more computed power spectrum values to determine whether the user performed at least one of a swipe action and a multi-touch action, across the display.

23. The device of claim 14 wherein the controller is further configured to detect the variations in the vibrations at a plurality of discrete times.

24. The device of claim 14 wherein the controller is further configured to detect the variations in the vibrations at a plurality of discrete time intervals.
